(19) United States
(12) Patent Application Publication
(10) Pub. No.: US 2018/0253666 A1
(43) Pub. Date: Sep. 6, 2018

(54) AUTOMATIC RESERVATION OF MEETING SPACE THROUGH COMMUNAL MEETING DEVICE

(71) Applicant: MICROSOFT TECHNOLOGY LICENSING, LLC, Redmond, WA (US)

(72) Inventor: Gregory Q. Fix, Seattle, WA (US)

(73) Assignee: MICROSOFT TECHNOLOGY LICENSING, LLC, Redmond, WA (US)

(21) Appl. No.: 15/446,683

(22) Filed: Mar. 1, 2017

(51) Int. Cl. G06Q 10/02; G06Q 10/10

(52) U.S. Cl. CPC G06Q 10/02; G06Q 10/1095

(57) ABSTRACT

Sometimes meetings are scheduled on short notice, and finding an available meeting space in which to hold them may be difficult. Embodiments are directed to automatic reservation of a meeting space through a communal meeting device located therein allowing users to efficiently initiate meetings without the concern of being later disrupted and kicked out of the meeting space. For example, the communal meeting device may detect user activity within the meeting space and determine whether the meeting space has a scheduled meeting that intersects with a first time period starting with the detected activity. If there is no scheduled meeting that intersects, the communal meeting device may transmit a request to a communication service to reserve the meeting space for the user for the first time period, and initiate a meeting for the user at the meeting space for a duration of the first time period.

### BACKGROUND

In many scenarios, meetings, have to be scheduled on short notice in response to emergencies, receipt of important information, and/or to accommodate availability of all attendees, for example. Having a meeting space in which to hold the meeting may be crucial to ensure that all attendees are able to participate, the proper technology is accessible, and/or privacy, if necessary, can be achieved. In these situations, a host and attendees may simply seek out an unoccupied meeting space, such as a conference room, and commence the meeting. If the meeting space is not explicitly reserved, the meeting may be disrupted and the host and attendees kicked out of the meeting space by other users who had reserved the meeting room, unknowing that it was now occupied. Some meeting spaces have a screen on the exterior of the meeting space that includes a feature to explicitly reserve the meeting space. However, this feature may be not easily discoverable and upon discovery may still take several button presses, which may not be feasible if users are in a hurry to get the meeting started. Also, this feature is often only available in very high-end meeting spaces.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automatic reservation of a meeting space through a communal meeting device. The communal meeting device may be configured to detect an activity of a user within the meeting space and determine whether the meeting space has a scheduled meetings that intersects with a rust time period, where the first time period starts with the detected activity. In response to a determination that the meeting space does not have a scheduled meeting that intersects with the first time period, the communal meeting device may be configured to transmit a request to a communication service to reserve the meeting space for the user for the first time period. The communal meeting device may then be configured to initiate a meeting for the user at the meeting space for a duration of the first time period.

These and other features and advantages will be apparent from a reading of the following detailed description and a review of the associated drawings. It is to he understood that both the foregoing general description and the following detailed description are explanatory and do not restrict aspects as claimed.

### BRIEF DESCRIPTION OF THE DRAWINGS

FIG. 1 includes an example network environment where automatic reservation of ‘a meeting space may be,implemented;

FIG. 2 includes another example network environment where automatic reservation of a meeting space may be implemented;

FIG. 3 includes a conceptual diagram illustrating an example scenario in which a communal meeting device reserves a meeting space for a user;

FIG. 4 includes a flow process for automatic reservation of a meeting space through a communal meeting device;

FIG. 5 includes a flow process for monitoring activity within a meeting space following automatic reservation of the meeting space through a communal meeting device;

FIG. 6 is a networked environment, where a system according to embodiments may be implemented;

FIG. 7 is a block diagram of an example computing device, which may be used to automatically reserve a meeting space;

FIG. 8 illustrates a logic flow diagram of a method to automatically reserve a meeting space through a communal meeting device, according to embodiments.

### DETAILED DESCRIPTION

As briefly described above, embodiments are directed to automatic reservation of a meeting space through a communal meeting device. The communal meeting device may detect an activity of a user within the meeting space through a detection module that is configured to process signals received from one or more sensors or one or more inputs of the communal meeting device. The detected activity may be a motion, a sound, a connection of a client device to the communal meeting device, and/or an initiation of an unscheduled meeting through the communal meeting device, for example. The communal meeting device may be configured to determine whether the meeting space has a scheduled meeting that intersects with a first time period, where the first time period starts with the detected activity and ends based on a default time period, pre-set time slots, and a start time of a next scheduled meeting within the meeting space.

If there is a previously scheduled meeting that intersects with the first time period, the communal meeting device may provide an alert to the user that the meeting space is unavailable. If there is no previously scheduled meeting that intersects the first time period, the communal meeting device may transmit a request to the communication service to reserve the meeting space for the user for the first time period, and may initiate a meeting for the user at the meeting space for a duration of the first time period. The communal meeting device may be configured to monitor activity of the user within the meeting space, throughout the first time period, and may delete or extend the meeting based on whether activity within the meeting space is detected throughout and upon the expiration of the first time period.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for automatically reserving a meeting space through a communal meeting device. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

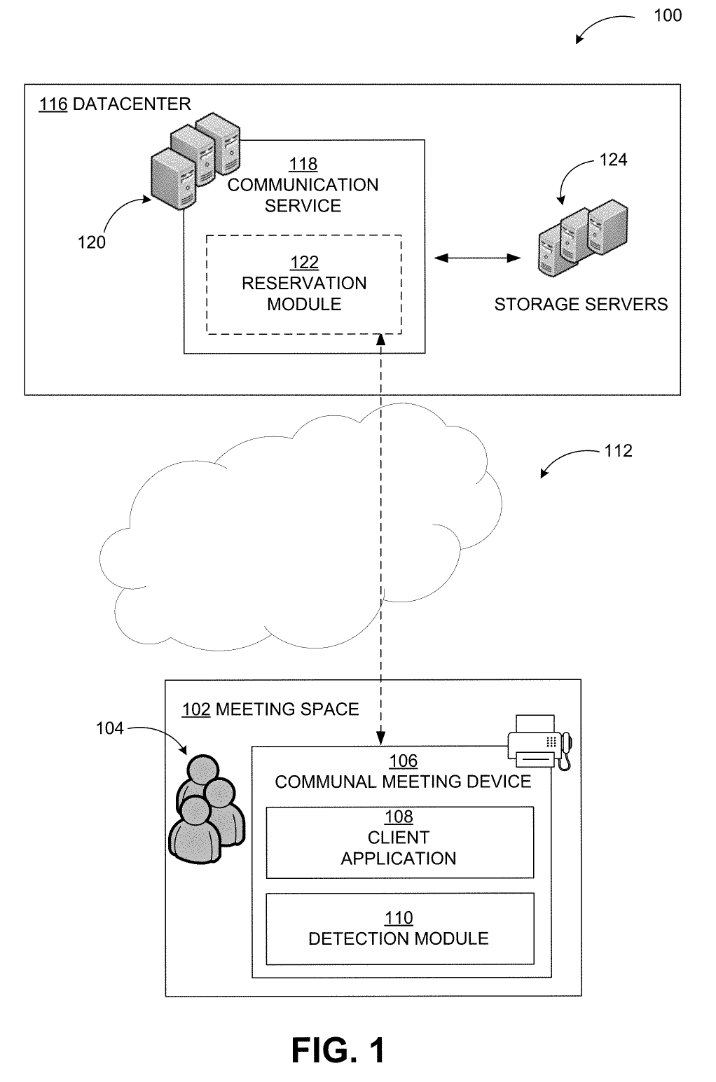

FIG. 1 includes an example network environment where automatic reservation of a meeting space may be implemented.

As illustrated in diagram 100, an example system may include a datacenter 116 hosting a cloud-based communication service 118 configured to enable users to share content, interact and communicate with one another, create and share calendars, and schedule meetings, among other things, through various communication modes, such as e-mail, text message, call and video conferencing and the like. The datacenter 116 may include one or more processing servers 120 configured to execute the communication service 118, among other components. In some embodiments, at least one of the processing servers 120 may be operable to execute a reservation module 122 of the communication service 118, where the reservation module 122 maybe integrated with the communication service 118 to reserve a meeting space 102 for one or more users 104 through a communal meeting device 106 located within the meeting space 102. The datacenter 116 may also include one or more storage servers 124 configured to manage one or more data stores comprising data associated with content stored by the communication service 118 and/or data associated with the reservation module 122. As described herein, the communication service 118 and/or reservation module 122 may be implemented as software, hardware, or combinations thereof.

In some embodiments, the communication service 118 may be configured to interoperate with various applications to provide its services. For example, as illustrated in the diagram 100, a thin (e,g,, a web browser) or a thick (e.g., a locally installed client application) version of a client application 108 may be executed by the communal meeting device 106 with which the communication service 118 may be configured to integrate and interoperate with over one or more networks, such as network 112. The client application 108 may be an application hosted by the communication service 118 such as a calendaring application, for example. The communal meeting device 106 may also include a detection module 110 that may be configured to process signals received from sensors and/or inputs of the communal meeting device 106. The communal meeting device 106 may include special purpose device with custom hardware and/or software components, as well as, a desktop computer, a laptop computer, a tablet computer, a smart phone, and a wearable computing device with custom components among other similar devices. A communication interface may facilitate communication between the communication service 118 and the communal meeting device 106 over the network 112.

In an example embodiment, the detection module 110 may receive signals from one or more sensors or one or more inputs of the communal meeting device 106. The sensors may include motion detectors, proximity sensors, optical sensors, cameras, microphones, near-field communication (NFC) devices, and/or Bluetooth devices, among other types of sensors. The inputs may include a high-definition multimedia interface (HDMI) port, and software entry points, among other types of inputs. The detection module 110 may be configured to process the signals received from the sensors and/or inputs of the communal meeting device 106 to detect an activity of the users 104 within the meeting space 102. The detected activity may be a motion, a sound, a connection of a client device to the communal meeting device 106, and/or an initiation of an unscheduled meeting through the communal meeting device 106, for example.

The communal meeting device 106 may be configured to determine whether the meeting space 102 has a scheduled meeting that intersects a first time period. The first time period may start when the activity is initially detected within the meeting space 102. In one embodiment, the first time period may end based on a default time period, such as 30 minutes. For example, if the activity is initially detected at 10:08 am, the first time period may extend 30 minutes until 10:38 am. In another embodiment, the first time period may end based on pre-set time slots. For example, if the activity is initially detected at 10:08 am and time slots are pre-set for every half of an hour, the first time period may extend until 10:30 am. In a further embodiment, the first time period may end at a start time of the next scheduled meeting within the meeting space 102. For example, lithe activity is initially detected at 10:08 am and the next scheduled meeting within the meeting space 102 is for 11:00 am, the first time period may extend until 11:00 am.

If there is a previously scheduled meeting that intersects with the first time period, the communal meeting device 106 may provide an alert to the users 104 to indicate that the meeting space 102 is unavailable. The alert may be projected audibly and/or visually through outputs of the communal meeting device 106, for example. The alert may include a time or duration of the previously scheduled meeting that intersects with the first time period, organizers or attendees of the previously scheduled meeting, and a topic or subject matter of the previously scheduled meeting, among other examples. This information may provide the users 104 an opportunity to contact those organizers or attendees to see if they would be willing to move their previously scheduled meeting to a new time or meeting space, for example. If there is no previously scheduled meeting that intersects the first time period, the communal meeting device 106 may transmit a request to the reservation module 122 of the communication service 118 to reserve the meeting space 102 for the users 104 for the first time period. The communal meeting device 106 may then initiate a meeting for the users 104 at the meeting space 102 for a duration the first time period.

If reserved, the communal meeting device 106 may be configured to monitor activity of the users 104 within the meeting space 102 throughout the first time period. The communal meeting device 106 may be configured to delete and/or extend the reservation based on whether activity is continuously detected within the meeting space 102 during and upon the expiration of the first time period. For example, in a first scenario, the detection module 110 may no longer be receiving signals from the sensors and/or inputs of the communal meeting device 106 before or upon expiration of the first time period, which may indicate a discontinuation of activity by the users 104 in the meeting space 102. Alternatively, in a second scenario, the detection module 110 may continue to receive signals from the sensors and/or inputs of the communal meeting device 106 during and even past the expiration of the first time period, which may indicate continued activity by the users 104 in the meeting space 102.

In the first scenario, where a discontinuation of activity is detected before or upon an expiration of the first time period, the communal meeting device 106 may delete the meeting. In one embodiment, the meeting may be immediately deleted. In another embodiment, a buffer time period may be initiated in response to detecting the discontinuation of activity, and the meeting may be deleted upon an expiration of the buffer time period (unless of course activity is re-detected during the buffer time period). Determining whether to immediately delete the meeting or initiate the buffet time period may be based on a type of the activity that is discontinued. For example, if the users 104 leave the meeting space 102, the meeting may be immediately deleted. Alternatively, if one of the users 104 disconnects a client device from the communal meeting device 106, a buffer time period may be initiated. If other activity of the users 104 is still detected at the expiration of the buffer time period, the meeting, will not be deleted. However, if the users 104 then leave the meeting space 102 shortly after the disconnection of the device such that no further activity is detected, the meeting will be deleted upon the expiration of the buffer time period.

Alternatively, in the second scenario where continued activity of the users 104 within the meeting space 102 is detected upon the expiration of the first time period, the communal meeting device 106 may be configured to transmit a request to the reservation module 122 to reserve the meeting space 102 for the users 104 for a second time period. The communal meeting device 106 may then be configured to extend the meeting for the users 104 at the meeting space 102 for a duration of the second time period. However, prior to extending the meeting, the communal meeting device 106 must first determine whether there is a scheduled meeting that would intersect with the second time period. If there is a previously scheduled meeting that would intersect with the second time period, the communal meeting device 106 may provide an alert to the users 104 to indicate that the meeting space 102 is unavailable for extension. If there is no previously scheduled meeting that would intersect with the second time period, the communal meeting device 106 may extend the meeting for the users 104 at the meeting space 102 for the duration of the second time period. The second time period may start at the expiration of the first time period. The second time period may end based on a default time period, pre-set time slots, or a start time of the next scheduled meeting within the meeting space 102. Both the first and second time periods may end based on a same criteria with similar or differing features. For example, each may end based on a default period of 30 minutes or each may end based on a default period but one default period is 30 minutes and the other is 15 minutes. Alternatively, the first and second times periods may end based on different criteria. For example, the first time period may end based on a pre-set time slot, and the second time period may end based on the start time of the next scheduled meeting within the meeting space 102.

Similar to the monitoring performed throughout the first time period, the communal meeting device 106 may monitor activity of the users 104 throughout the second time period. The communal meeting device 106 may be configured to delete and/or extend the reservation based on whether activity is continuously detected within the meeting space 102 during and upon the expiration of the second time period. The communal meeting device's activity monitoring followed by deletion or extension of the meeting, before or upon expiration of a particular time period may be repeated for up to n time periods.

In additional embodiments, the detection module 110 may be configured to determine an identity of the users 104 within the meeting space 102 by processing signals received from the sensors and/or inputs of the communal meeting device 106. For example, the users 104 may be wearing employee badges. A barcode on each badge may be read by a sensor of the communal meeting device 106, such as a barcode reader, and the detection module 110 may process the scanned barcode to identify the user associated with each badge. In other embodiments, the users 104 may be, identified through a user identification associated with a client device connected to the communal meeting device 106, entry of identification information into the communal meeting device 106, or biometric means such as finger printing, facial recognition, voice recognition, and iris recognition, among other examples. In one example, the communal meeting device 106 may provide the identity of the users 104 to the reservation module 122 of the communication service 118, wherein the reservation module 122 is configured to associate the identified users 104 with the reserved meeting space 102 in other examples, the meeting space 102 may be recorded for a duration of the meeting through sensors and/or inputs of the communal meeting device 106, and the communal meeting device 106 and/or communication service 118 may be configured to send the recording to the identified users 104.

As previously mentioned, meetings may have to he scheduled on short notice in response to emergencies, receipt of important information, and/or to accommodate availability of all attendees, for example. Having a meeting space in which to hold the meeting may be crucial to ensure that all attendees are able to participate, the proper technology is accessible, and/or privacy, if necessary, can be achieved. If the meeting space is not explicitly reserved, the meeting may be disrupted and the host and attendees kicked out of the meeting space by other users who had previously reserved the meeting space or reserved the meeting space after the present meeting started, unaware that it was occupied. Some meeting spaces have a screen on an exterior of the meeting room which allow you to explicitly reserve the room with a couple of button presses. However, this requires users to explicitly press the buttons to reserve the room, which may not he feasible if users are in a hurry to get the meeting started. Also, this feature is not easily discoverable and is only available in very high-end meeting spaces.

Embodiments as described herein, allow users to quickly and efficiently initiate short-notice meetings within a meeting space without the concern of being later disrupted and kicked out of the meeting space. For example, the simple act of a user walking into a meeting space, such as a conference room, in which a communal meeting device is located may trigger automatic reservation of the meeting space if it is available and/or immediate provision of an alert to the user that the meeting space is unavailable due to a previously scheduled meeting, which increases user efficiency. Additionally, if the meeting ends early, the reservation of the meeting space may be released so that it is available to others seeking space. Furthermore, if the meeting goes longer than the initially reserved time period, the communal meeting device may automatically extend the meeting for the user at the meeting space for additional time periods as long as they do not conflict with previously scheduled meetings for that meeting space.

Embodiments, as described herein, address a need that arises from very large scale of operations created by software bayed services that cannot be managed by humans. The actions/operations described herein are not a mere use of a computer, but address results of a system that is a direct consequence of software used as a service offered in conjunction with large numbers of users attempting to schedule meetings within a limited number of meeting spaces through communication services.

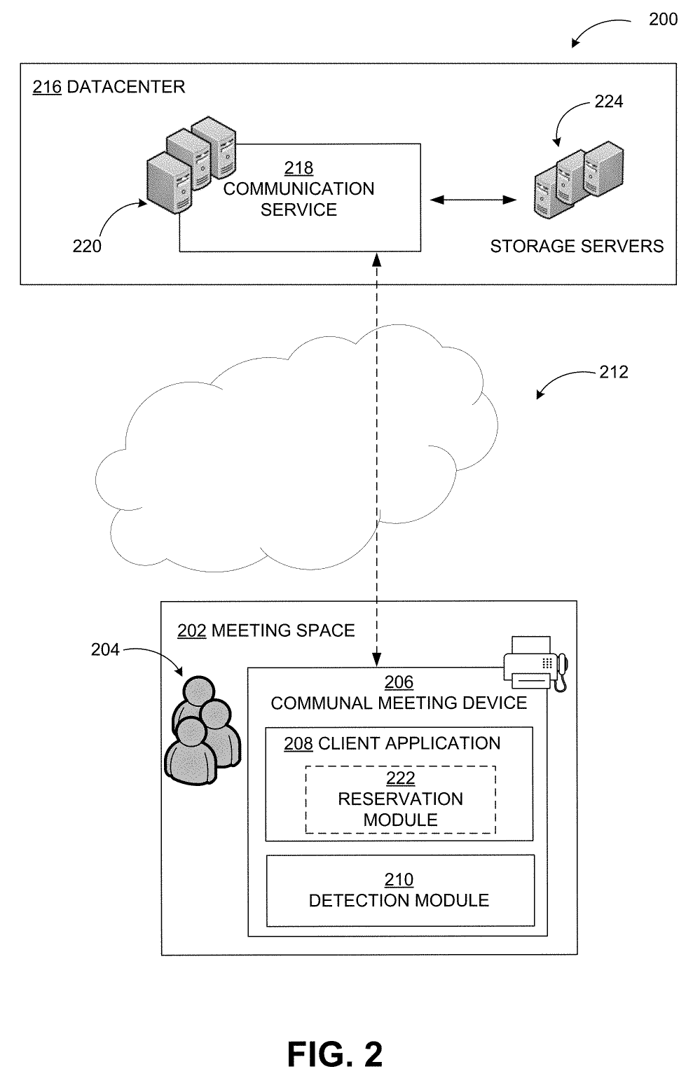

FIG. 2 includes another example network environment where automatic reservation of a meeting space may be implemented.

As illustrated in diagram 200, a thin (e.g., a web browser) or a thick (e.g., a locally installed client application) version of a client application 208 may be executed by a communal meeting device 206, where the client application 208 may be a calendaring application, for example. The client application 208 may be operable to execute a reservation module 222 integrated with he client application 208. The communal meeting device 206 may include special purpose device or a customized general purpose computing device among other similar devices. The communal meeting device 206 may also include a detection module 210 configured to process signals received from one or more sensors or one or more inputs of the communal meeting device 206.

A cloud-based communication service 218 executed by at least one or more processing servers 220 of a datacenter 216 may be configured to interact with the client application 208 over one or more networks, such as network 212. The datacenter 216 may also include one or more storage servers 224 configured to manage one or more data stores comprising data associated with content stored by the communication service 118 and/or data associated with the detection module 210 and the reservation module 222 received from the communal meeting device 206. A communication interface may facilitate communication between the communication service 218 and the communal meeting device 206 over the network 212.

In an example embodiment, the communal meeting device 206 may detect an activity of one or more users 204 within the meeting space 202 through a detection module 210 that is configured to process signals received from one or more sensors or one or more inputs of the communal meeting device 206. The detected activity may be a motion, a sound, a connection of a client device to the communal meeting device, and/or an initiation of an unscheduled meeting through the communal meeting device, for example. The reservation module 222 may be configured to determine whether the meeting space 202 has a scheduled meeting that intersects with a first time period, where the first time period starts with the detected activity and ends based on a default time period, pre-set time slots, and a start time of a next scheduled meeting within the meeting space 202.

If there is a previously scheduled meeting that intersects with the first time period, the communal meeting device 206 may provide an audible or visual alert to the users 204 that the meeting space 202 is unavailable. If there is no previously scheduled meeting that intersects the first time period, the reservation module 222 may transmit a request to the communication service 218 to reserve the meeting space 202 for the users for the first time period, and the client application 208 may initiate a meeting for the users 204 at the meeting space 202 for a duration of the first time period. The communal meeting device 206 may be configured to monitor activity of the users 204 within the meeting space 202 throughout the first time period via its sensors and/or inputs, and may delete or extend the meeting based on whether the activity within the meeting space 202 is detected throughout and upon the expiration of the first time period.

In an example scenario, the users 204 may enter into the meeting space 202 at 2:13 pm carrying on conversations. A motion detector and a microphone of the communal meeting device 206 may collect these motions and sounds, and transmit signals to the detections module 210 for processing. Upon receipt of these signals indicating activity within the meeting space 202, the first time period is initiated and the first time period may end based on pre-set, one hour time slots. Therefore, the first time period may begin at 2:13 pm and end at 3:00 pm. The reservation module 222 may determine whether the meeting space 202 has a scheduled meeting between 2:13 pm and 3:00 pm. In response to determining that there is no conflicting, previously scheduled meeting, the reservation module 222 may transmit a request to reserve the meeting, space 202 to the communication service 218. The client application 20$ may then be configured to initiate the meeting for the users 204 from 2:13 pm until 3:00 pm. For example, the client application 208 may initiate a video conference with other users located in another meeting through the communal meeting device 206.

At 2:25 pm, the communal meeting device 206 may detect that the video conference has been discontinued. Therefore, the communal meeting device 206 may initiate a buffer period of 15 minutes. If no further activity is detected in the meeting space at 2:40 pm (that is, the expiration of the 15-minute buffer period), then the reservation module 222 may be configured to delete the meeting early before the expiration of the first time period. This in turn deletes the reservation of the meeting space 202 such that others may reserve and use the meeting space 202 if needed. Alternatively, although the video conference has been discontinued, the users 204 may remain in the room to discuss other matters or present additional information. Therefore, if at 2:40 pm, movement and sounds are still detected within the meeting space 202, the communal meeting device 206 may not delete the meeting.

If there is still continued activity upon the expiration of the first time period at 3:00 pm, the reservation module 222 may be configured to determine whether the meeting space 202 has a scheduled meeting that intersects with a second time period. The second time period may start upon the expiration of the first time period and may end based on pre-set, one hour time slots, similar to the second time period. Therefore, the first time period may begin at 3:00 pm and end at 4:00 pm. The reservation module 222 may determine that there is a previously scheduled meeting within the meeting space 202 at 3:30 pm. Therefore, the communal meeting device 206 may provide an alert to the users 204 that the meeting space is unavailable. The alert may be projected audibly through speakers and/or visually through an interface of the communal meeting device 206, for example. The alert may also include a time or duration of the previously scheduled meeting that intersects, an organizer or attendee of the previously scheduled meeting, and a topic or subject matter of the previously scheduled meeting, among other examples. This may allow the users 204 to determine how much longer they can utilize the meeting space (e.g., until 3:30 pm) or if the topic seems of low importance, the users 204 may be comfortable contacting the organizer to see if they can push back the previously scheduled meeting or hold it elsewhere.

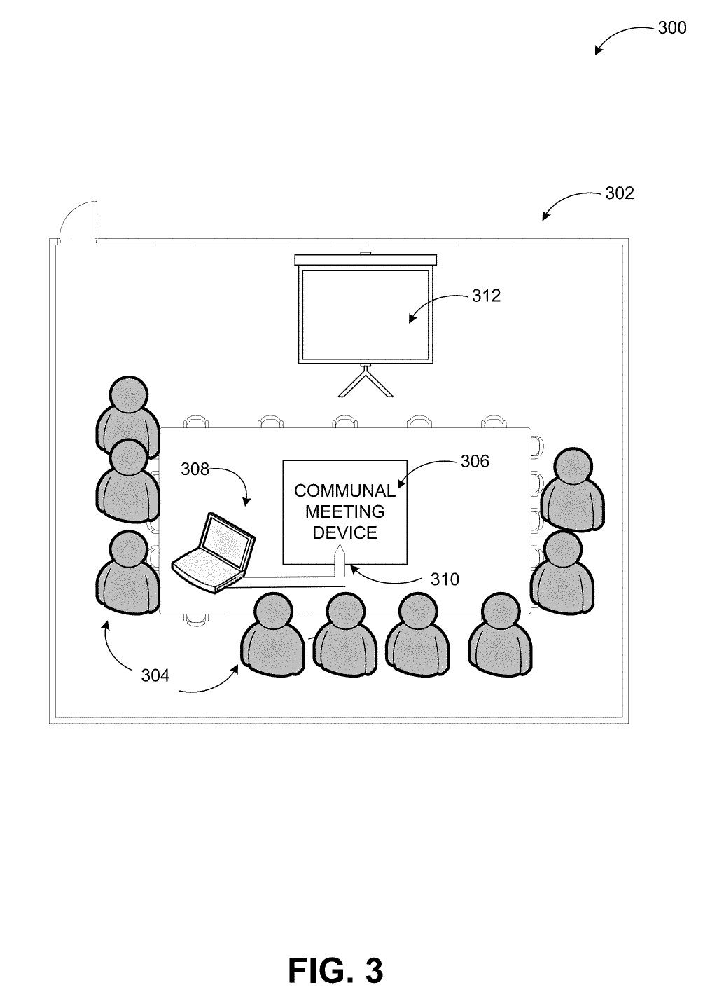

FIG. 3 includes a conceptual diagram illustrating an example scenario in which a communal meeting device reserves a meeting space for a user.

In an example scenario, a corporation's agent of service may be served with a complaint alleging the corporation has violated various anti-trust laws. The agent may send an email to lawyers comprising the corporation's in-house counsel. Wanting to get on top of the situation before any details are leaked to the media, the lawyers may decide to hold an emergency meeting with the board members of the organization. Unaware of the availability of each conference room within corporate headquarters and not having time to reserve one, attendees 304 may just enter into the first, unoccupied space they find, such as conference room 302.

A communal meeting device 306 located in the conference room 302 may detect a connection of a client device 308 to the communal meeting device 306 through an input 310, such as a HDMI port. Upon detecting the connection, the communal meeting device 306 may determine whether the conference room 302 already has a scheduled meeting that intersects with a first time period. The first time period may be initiated when the activity is detected, and the first time period may end based on a default time period, such as 30 minutes. Therefore, if the client device 308 is connected to the communal meeting device 306 through the,input at 9:20 am, a duration of the first time period may be from 9:20 am to 9:50 am. The communal meeting device 306 may determine that there is no conflicting, previously scheduled meeting. Thus, the communal meeting device 306 may transmit a request to reserve the conference room 302 to a communication service communicatively coupled to the communal meeting device 306. The communal meeting device 306 may then be configured to initiate the meeting for the attendees 304 from 9:20 am to 9:50 am. For example, the communal meeting device may initiate a presentation of content onto, a projector 312 located within the conference room 302.

Throughout and upon the expiration of the first time period at 9:50 am, the communal meeting device 306 may continue to detect activity within the conference room 302. For example, the client device 308 may still be connected to the communal meeting device 306 through the input 310, and other sensors of the communal meeting device 306 may detect attendees moving around and/or talking within the conference room 302. In response to the continued activity, the communal meeting device 306 may determine whether the conference room 302 has a scheduled meeting that intersects with a second time period. The second time period may start upon the expiration of the first time period and may end based on delimit time periods, similar to the second time period. However, the default time period may be the same or different for the first and second time periods. In this example, the default time period may be 30 minutes for both the first and second time periods. Therefore, the first time period may begin at 9:50 am and end at 10:20 am. The communal meeting device 306 may determine that there is not a previously scheduled meeting that conflicts with the second time period. Therefore, the communal meeting device 206 may transmit a request to reserve the conference room 302 for the attendees 304 for the second time period to the communication service, and may extend the meeting for a duration of the second time period until 10:20 am.

Similar to the monitoring performed throughout the first time period, the communal meeting device 306 may monitor activity of the attendees 304 throughout the second time period. At 10:00 am, the communal meeting, device 306 may detect disconnection of the client device 308. Therefore, the communal meeting device 306 may initiate a buffer period of 5 minutes. A few minutes after disconnection of the client device 308, the attendees 304 may leave the room. Therefore, no further activity may be detected within the conference room 302 at 10:05 am (that is, the expiration of the 5-minute buffer period), and the communal meeting device 306 may be configured to delete the meeting early before the expiration of the second time period. This in turn deletes the reservation of the conference room 302 such that others may use the conference room 305 for meetings if needed.

For a duration of the meeting, a recording mechanism associated and/or integrated with the communal meeting device 306 may have recorded the presentation, for example, along with the activity occurring within the conference room 306. In some embodiments, a user identification associated with the client device 308 connected to the communal meeting device 306 may be used to identify at least one of the attendees 304 associated with the client device 308. In other embodiments, one or more of the attendees 104 may be identified through scanning of badges, entry of identification information into the communal meeting device 306, and biometric means, such as finger printing, facial recognition, voice recognition, and iris recognition, among other examples. Identification of the attendees 304 may enable the communal meeting device 306 in conjunction with the communication service to provide the recording of the presentation to each of the attendees through email, for example.

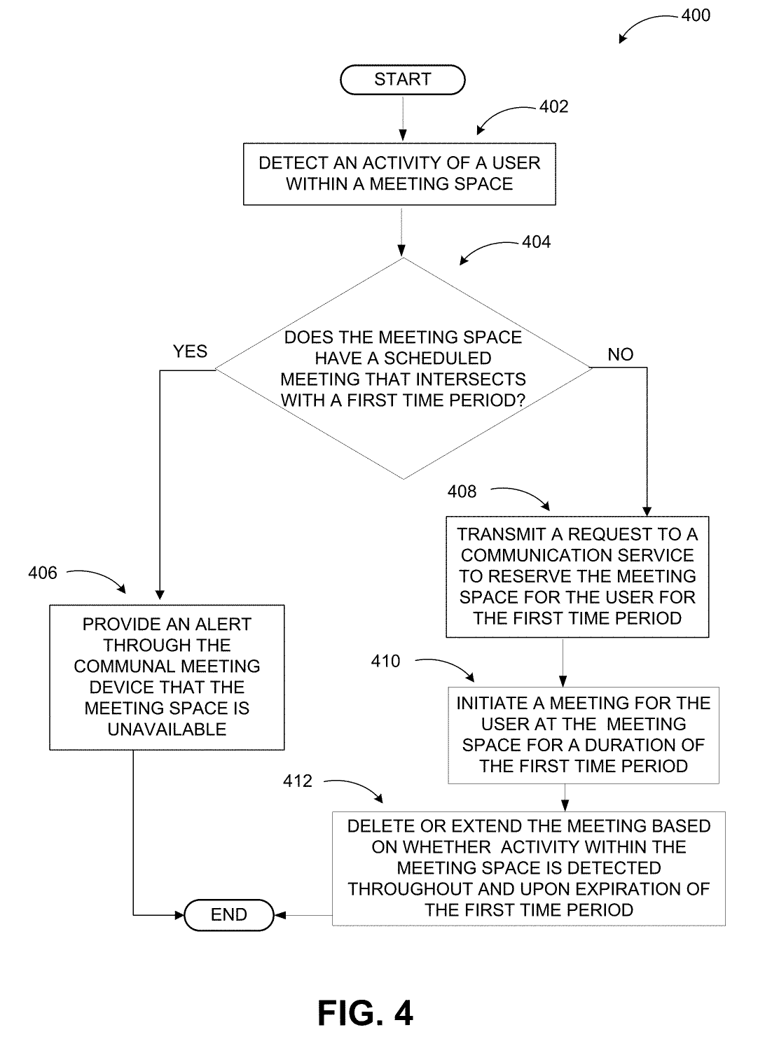

FIG. 4 includes a flow process for automatic reservation of a meeting space through a communal meeting device.

As shown in a diagram 400, a communal meeting device located within a meeting space may detect an activity of a user in the meeting space 402. The communal meeting device may then determine whether the meeting space has a scheduled meeting that intersects a first time period 404. The first time period may start when the activity is initially detected within the meeting space, and may end based on a default time period, pre-set time slots, or a start time of the next scheduled meeting within the meeting space.

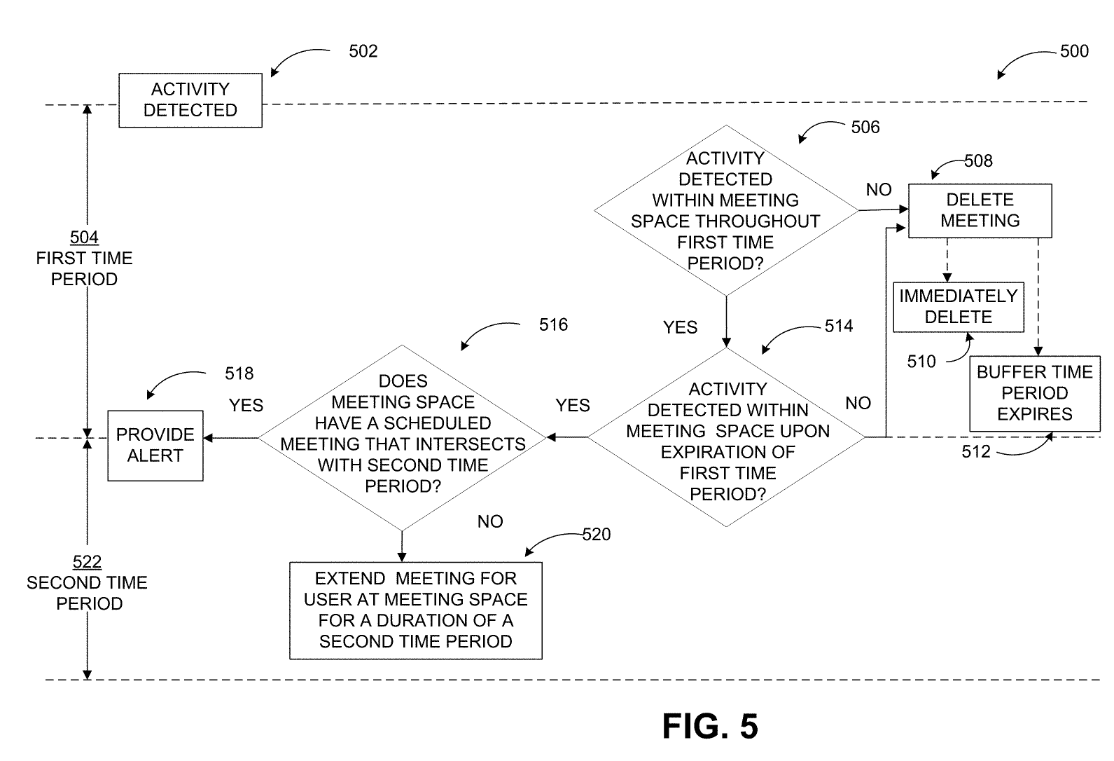

If there is a previously scheduled meeting that intersects with the first time period, the communal meeting device may provide an alert that indicates the meeting space is unavailable 406. If there is no previously scheduled meeting that intersects the first time period, the communal meeting device may transmit a request to a communication service to reserve the meeting space for the users for the first time period 408. The communal meeting device may then initiate a meeting for the users at the meeting space for a duration the first time period 410. The communal meeting device may be configured to monitor activity of the user within the meeting space throughout the first time period, and may delete or extend the meeting based on whether the activity within the meeting space is detected throughout and upon the expiration of the first time period 412, as discussed in greater detail in FIG. 5 below.

FIG. 5 includes a flow process for monitoring activity within a meeting space following automatic reservation of the meeting space through a communal meeting device.

As shown in a diagram 500, once an activity of a user within a meeting space may be detected 502, a meeting may be initiated for the user at the meeting space for a duration of a first time period 504 through a communal meeting device following the process described in conjunction with FIG. 4. The communal meeting device may then be configured to determine whether activity of the user is detected within the meeting space throughout the first time period 504, as illustrated by decision 506. The first period 504 may start when the activity is detected 502, and may end based on a default time period, pre-set time slots, or a start time of the next scheduled meeting within the meeting space. In response to detecting a discontinuation of activity at any point before an expiration of the first time period 504, the communal meeting device may delete the meeting 508 in one of two manners based on a type of the activity that is discontinued. In one embodiment, the meeting may be immediately deleted 510. In another embodiment, a buffer time period may be initiated in response to detecting the discontinuation of activity, and the meeting may be deleted upon an expiration of the buffer time period 512 (unless activity is re-detected during the buffer time period).

If activity has been detected within the meeting space prior to the expiration of the first time period 504, the communal meeting device may be configured to then determine whether activity of the user is detected within meeting space upon expiration of the first time period 504, as illustrated by decision 514. In response to detecting a discontinuation of activity upon the expiration of the first time period 504, the communal meeting device may delete the meeting 508 in one of the two manners described previously.

Alternatively, if continued activity of the user within the meeting space is detected upon the expiration of the first time period, the communal meeting device may be configured to determine whether the meeting space has a scheduled meeting that would intersect with a second time period 522, as illustrated by decision 516. If there is a previously scheduled meeting that would intersect with the second time period 522, the communal meeting device may provide an alert 518 to the user to indicate that the meeting space is unavailable for extension. If there is no previously scheduled meeting that would intersect with the second time period 522, the communal meeting device may extend the meeting 520 for the users at the meeting space for the duration of the second time period 522. The second time period 522 may start at the expiration of the first time period. The second time period 522 may end based on a default time period, pre-set time slots, or a start time of the next scheduled meeting within the meeting space. The communal meeting device's activity monitoring followed by deletion or extension of the meeting before or upon expiration of a particular time period may be repeated for up to n time periods.

The examples provided in FIGS. 1 through 5 are illustrated with specific systems, services, applications, modules, and notifications. Embodiments are not limited to environments according to these examples. Automatic reservation of a meeting space through a communal meeting device may be implemented in environments, employing fewer or additional systems, services, applications, modules, and notifications. Furthermore, the example systems, services, applications, modules, and notifications shown in FIG. 1 through 5 may be implemented in a similar manner with other values using the principles described herein.

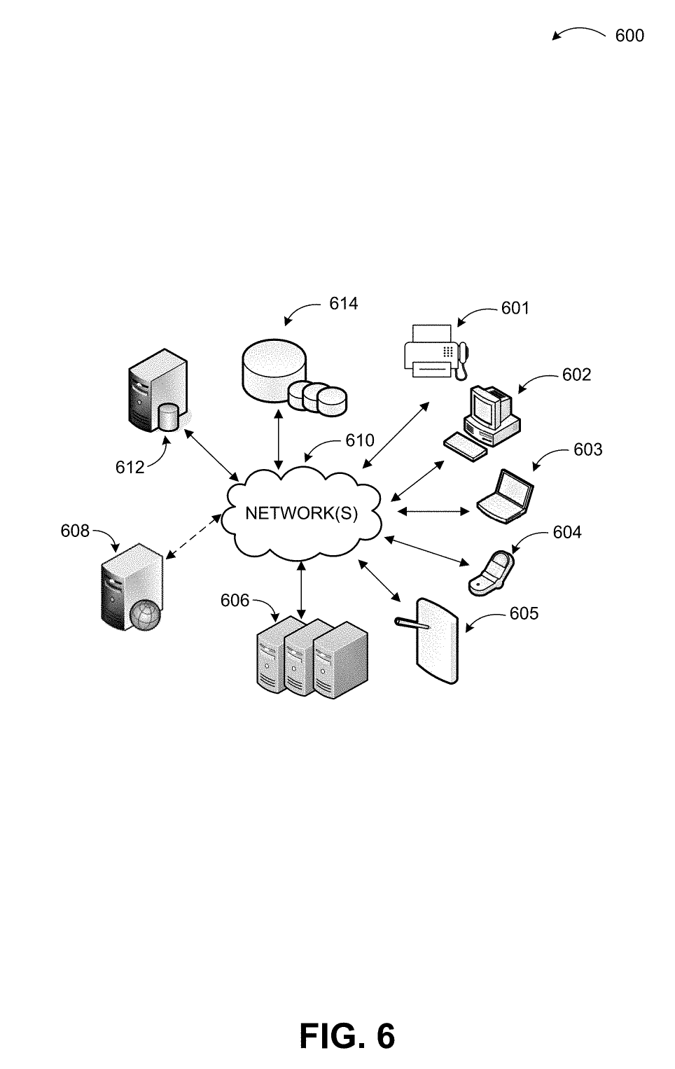

FIG. 6 is a networked environment, where a system according to embodiments may be implemented. In addition to locally installed applications (for example, client application 208), a reservation module may also be employed in conjunction with hosted applications and services (for example, a communication service 118) that may be implemented via software executed over one or more servers 606 or individual server 608, as illustrated in diagram 600. A hosted service or application may communicate with client applications on individual computing devices such as a communal meeting device 601, a desktop computer 602, a laptop computer 603, a smart phone 604, a tablet computer (or slate), 605 (‘client devices’) through network(s) 610 and control a user interface presented to users.

Client devices 601-605 are used to access the functionality provided by the hosted service or application. One or more of the servers 606 or server 608 may be used to provide a variety of services as discussed above. Relevant data may be stored in one or more data stores (e.g. data store 614), which may be managed by any one of the servers 606 or by database server 612.

Network(s) 610 may comprise any topology of servers, clients, Internet service providers, and communication media. A system according to embodiments may have, a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation network(s) 610 may include wireless media such as acoustic, RF, infrared and other wireless media.

Many other configurations of computing devices, applications, engines, data sources, and data distribution systems may be employed for automatic reservation of a meeting space. Furthermore, the networked environments discussed in FIG. 6 are for illustration purposes only. Embodiments are not limited to the example applications, engines, or processes.

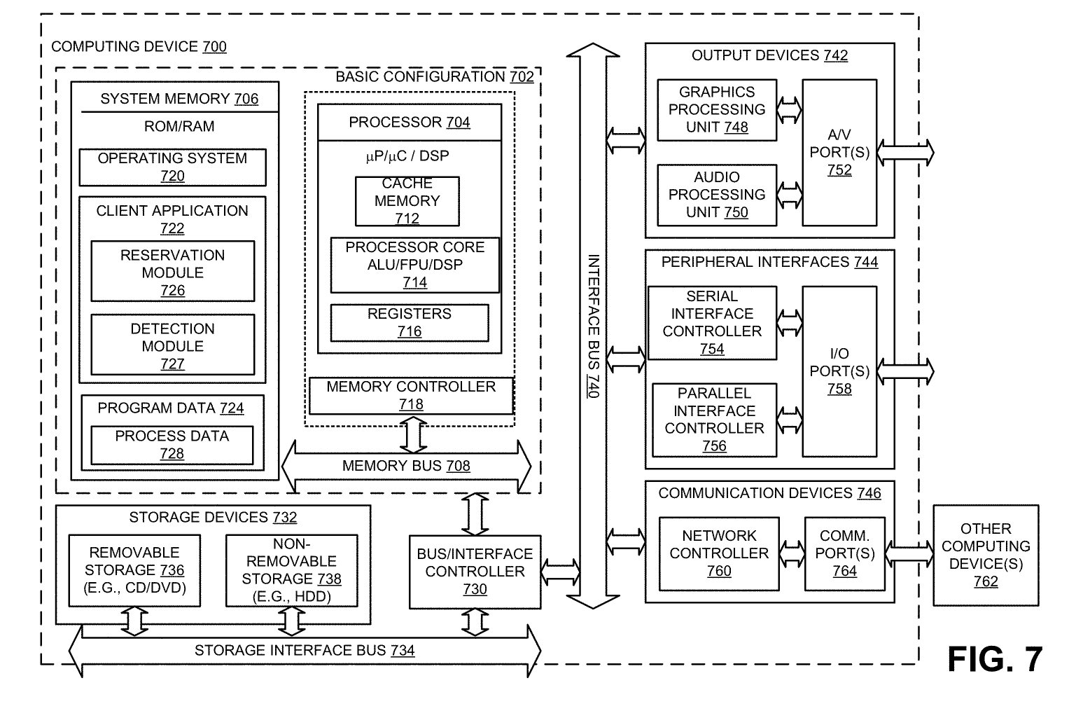

FIG. 7 is a block diagram of an example computing device, which may be used to automatically reserve a meeting space.

For example, computing device 700 may be a communal meeting device, where the communal meeting device may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a client application 722 associated with a communication service such as a calendaring application, and program data 724. The client application 722 may include a reservation module 726. Upon detection of user activity within the meeting space through the processing of signals collected from sensors and/or inputs of the communal meeting device, the reservation module 726 may be configured to determine whether the meeting space has a scheduled meeting that intersects with a first time period starting with the detected activity and ending based on a default time period, pre-set time slots, and a start time of a next scheduled meeting within the meeting space. In response to a determination that the meeting space does not have a scheduled meeting that intersects the lust time period, the reservation module 726 may transmit a request to the communication service to reserve the meeting space for the user for the first time period. A meeting may then be initiated for the user at the meeting space for a duration of the first time period. The program data 724 may include, among other data, process data 728, such as detected user activity, meeting space availability, and meeting space reservations, as described herein.

The computing device 700 may have additional, features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more 110 ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically he embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a specialized server, mainframe, or similar computer that includes any of the above functions. The computing device 700 may also be implemented as a personal computer including both laptop computer and non-laptop computer configurations.

Example embodiments may also include methods to automatically reserve a meeting space through a communal meeting device. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

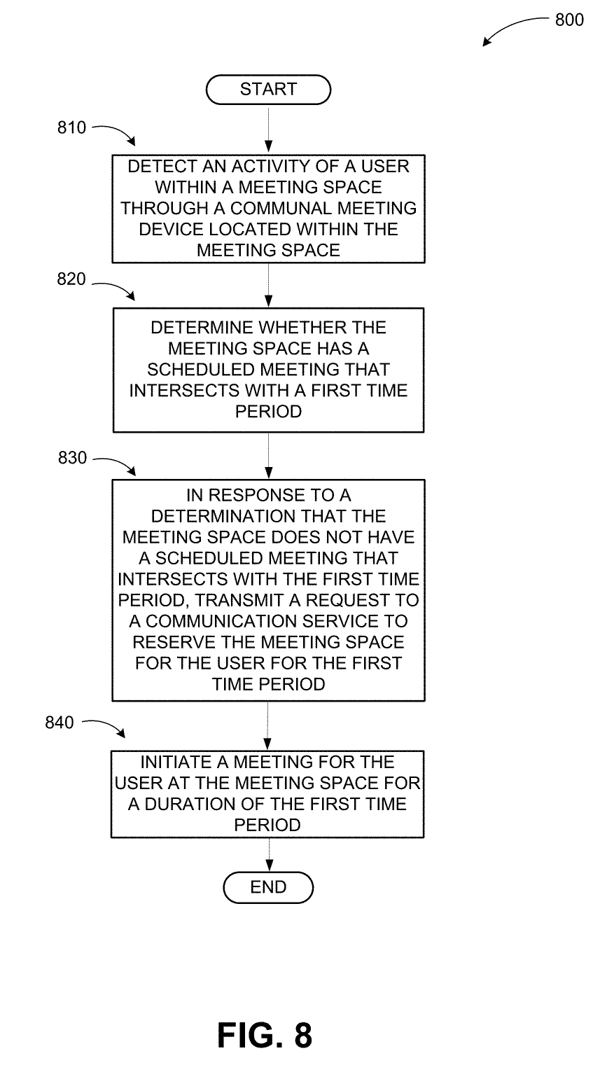

FIG. 8 illustrates a logic flow diagram of a method to automatically reserve a meeting space through a communal meeting device.

Process 800 may be implemented on a computing device, server, or other system. An example system may include a server configured to execute a communication service and a communal meeting device configured to reserve a meeting space for a user. The communal meeting device may include a communication interlace to facilitate communication between the communication service and the communal meeting device, a memory to store instructions, and one or more processors coupled to the memory.

Process 800 begins with operation 810, where the communal meeting device may detect an activity of the user within the meeting space. The communal meeting device may include a detection module that is configured to process signals received from one or more sensors or one or more inputs of the communal meeting device to detect the activity. The sensors may include motion detectors, proximity sensors, optical sensors, cameras, microphones, near-field communication (NFC) devices, and/or Bluetooth devices, among other types of sensors. The inputs may include a high-definition multimedia interface (HDMI) port and software entry points, among other types of inputs. The detected activity may be a motion, a sound, a connection of a client device to the communal meeting device, and/or an initiation of an unscheduled meeting through the communal meeting device, for example.

At operation 820, the communal meeting device may be configured to determine whether the meeting space has a scheduled meeting that intersects with a first time period. The first time period may start with the detected activity, and may end based on a default time period, pre-set time slots, and a start time of a next scheduled meeting within the meeting space. If there is a scheduled meeting that intersects with the first time period, then the communal meeting device may provide an alert to indicate the user that the meeting space is unavailable due to a previously scheduled meeting for the meeting space. Otherwise, at operation 830, the communal meeting device may transmit a request to the communication service to reserve the meeting space for the user for the first time period in response to a determination that the meeting space does not have a scheduled meeting that intersects with the first time period.

At operation 840, the communal meeting device may initiate a meeting for the user at the meeting space for a duration of the first time period. For example, the communal meeting device may initiate a video or audio conference, initiate a presentation, or the like. The communal meeting device may then be configured to monitor activity of the user within the meeting space throughout the first time period, and may delete or extend the meeting based on whether activity of the user within the meeting space is detected throughout and upon the expiration of the first time period.

The operations included in process 800 are for illustration purposes. Automatic reservation of a meeting space through a communal meeting device may be implemented by similar processes with fewer or additional steps, as well as in different order of operations using the principles described herein. The operations described herein may be executed by one or more processors operated on one or more computing devices, one or more processor cores, and/or one or more specialized processing devices, among other examples.

According to examples, a means for reserving a meeting space through a communal meeting device located within the meeting space is described. The means may include a means for detecting an activity of a user within the meeting space; a means for determining whether the meeting space has a scheduled meeting that intersects with a first time period, where the first time period starts with the detection of the activity; a means for transmitting a request to a communication service to reserve the meeting space for the user for the first time period in response to a determination that the meeting space does not have a scheduled meeting that intersects with the first time period; and a means for initiating a meeting for the user at the meeting space for a duration of the first time period.

According to some examples, a method to reserve a meeting space through a communal meeting device located within the meeting space is described. The method may include detecting an activity of a user within the meeting space; determining whether the meeting space has a scheduled meeting that intersects with a first time period, where the first time period starts with the detection of the activity; in response to a determination that the meeting space does not have a scheduled meeting that intersects with the first time period, transmitting a request to a communication service to reserve the meeting space for the user for the first time period; and initiating a meeting for the user at the meeting space for a duration of the first time period.

According to other examples, detecting the activity of the user in the meeting space may include detecting the activity through a sensor or an input of the communal meeting device. The detected activity may include one or more of a motion, a sound, a connection of a client device to the communal meeting device, and an initiation of an unscheduled meeting through the communal meeting device. The method may also include in response to an expiration of the first time period and a detection of continued activity of the user within the meeting space; transmitting a request to the communication service to reserve the meeting space for a second time period; and extending the meeting for the user at the meeting space for a duration of the second time period.

According to farther examples, the method may further include prior to transmitting the request to the communication service to reserve the meeting space for the second time period, determining whether the meeting space has a scheduled meeting that intersects with the second time period. The method may also include deleting the meeting for the user before or upon an expiration of the first time period in response to detecting a discontinuation of the activity within the meeting space. The meeting may be immediately deleted in response to detecting the discontinuation of the activity within the meeting space. A buffer time period may be initiated in response to detecting the discontinuation of the activity within the meeting space, and the meeting is deleted upon an expiration of the buffer time period. The method may also include determining whether to immediately delete the meeting or initiate a buffer time period based on a type of the activity that is discontinued. The method may further include in response to a determination that the meeting space does have a scheduled meeting that intersects with the first time period, providing an alert to the user through the communal meeting device.

According to other examples, a communal meeting device located within a meeting space and configured to reserve the meeting space is described. The communal meeting device may include a communication interlace configured to facilitate communication between a communication service and the communal meeting device; a memory configured to store instructions; and one or more processors coupled to the memory. The one or more processors, in conjunction with the instructions stored in the memory, may be configured to detect an activity of a user within the meeting space; determine whether the meeting space has a scheduled meeting that intersects with a first time period, where the first time period starts with the detection of the activity; in response to a determination that the meeting space does not have a scheduled meeting that intersects with the first time period, transmit a request to a communication service to reserve the meeting space for the user for the first time period; and initiate a meeting for the user at the meeting space for a duration of the first time period.

According to some examples, the communal meeting device may further include one or more sensors and one or more inputs to detect the activity, where the activity includes one or more of a motion, a sound, a connection of a client device to the communal meeting device, and an initiation of an unscheduled meeting through the communal meeting device. The first time period may end based on one of a default time period, pre-set time slots, and a start time of a next scheduled meeting within the meeting space. The processors may be further configured to monitor the activity of the user within the meeting space throughout the first time period.

According to other examples, the processors may be further configured to delete the meeting for the user before or upon an expiration of the first time period in response to detecting a discontinuation of the activity within the meeting space; or upon the expiration of the first time period, extend the meeting for the user at the meeting space for a duration of a second time period in response to detecting a continuation of the activity within the meeting space. The second time period may start at the expiration of the first time period and end based on one of a default time period pre-set time slots, and a start time of a next scheduled meeting within the meeting space.

According to further examples, a system to reserve a meeting space through a communal meeting device located within the meeting space is described. The system may include a server configured to execute a communication service and a communal meeting device. The communal meeting device may include a communication interface configured to facilitate communication between the communication service and the communal meeting device; a memory configured to store instructions; and one or more processors coupled to the memory, where the one or more processors, conjunction with the instructions stored in the memory, may be configured to detect an activity of a user within the meeting space; determine whether the meeting space has a scheduled meeting that intersects with a first time period, where the first time period starts with the detection of the activity; in response to a determination that the meeting space es not have a scheduled meeting that intersects with the first time period, transmit a request to a communication service to reserve the meeting space for the user for the first time period; initiate a meeting for the user at the meeting space for a duration of the first time period; and extend the meeting for the user at the meeting space for a duration of a second time period in response to detecting a continuation of the activity within the meeting space upon an expiration of the first time period.

According to yet other examples, the one or more processors may be further configured to determine an identity of the user within the meeting space through one or more sensors and one or more inputs of the communal meeting device. The one or more processors may also be configured to provide the identity of the user to the communication service, where the communication service is configured to associate the identified user with the meeting space. The one or more processors may be further configured to record the meeting space for a duration of the meeting through the one or more sensors and one or more inputs of the communal meeting device; and send the recording to the identified user.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claim and embodiments.

1. A method to reserve a meeting space through a communal meeting device located within the meeting space, the method comprising:
detecting an activity of a user within the meeting space;
determining whether the meeting space has a scheduled meeting that intersects with a first tune period, wherein the first time period starts with the detection of the activity;
in response to a determination that the meeting space does not have a scheduled meeting that intersects with the first time period, transmitting a request to a communication service to reserve the meeting space for the user for the first time period; and
initiating a meeting for the user at the meeting space for a duration of the first time period.

2. The method of claim 1, wherein detecting the activity of the user in the meeting space comprises:
detecting the activity through a sensor or an input of the communal meeting device.

3. The method of claim 2, wherein the detected activity includes one or more of a motion, a sound, a connection of a client device to the communal meeting device, and an initiation of an unscheduled meeting through the communal meeting device.

4. The method of claim 1, further comprising:
in response to an expiration of the first time period and a detection of continued activity of the user within the meeting space:
transmitting a request to the communication service to reserve the meeting space for a second time period; and
extending the meeting for the user at the meeting space for a duration of the second time period.

5. The method of claim 4, further comprising:
prior to transmitting the request to the communication service to reserve the meeting space for the second time period, determining whether the meeting, space has a scheduled meeting that intersects with the second time period.

6. The method of claim 1, further comprising:
deleting the meeting for the, user before or upon an expiration of the first time, period in response to detecting a discontinuation of the activity within the meeting space,

7. The method of claim 6, wherein the meeting is immediately deleted in response to detecting the discontinuation of the activity within the meeting space.

8. The method of claim 6, wherein a buffer time period is initiated in response to detecting the discontinuation of the activity within the meeting space, and the meeting is deleted upon an expiration of the buffer time period.

9. The method of claim 6, further comprising:
determining whether to immediately delete the meeting or initiate a buffer time period based on a type of the activity that is discontinued.

10. The method of claim 1, further comprising:
in response to a determination that the meeting space does have a scheduled meeting that intersects with the first time period, providing an alert to the user through the communal meeting device.

11. A communal meeting device located within a meeting space and configured to reserve the meeting space, the communal meeting device comprising:
a communication interface configured to facilitate communication between a communication service and the communal meeting device;
a memory configured to store instructions; and
one or more processors coupled to the memory, wherein the one or more processors, in conjunction with the instructions stored in the memory, are configured to:
detect art activity of a user within the meeting space;
determine whether the meeting space has a scheduled meeting that intersects with a first time period, wherein the first time period starts with the detection of the activity;
in response to a determination that the meeting space does not have a scheduled meeting that intersects with the first time period, transmit a request to a communication service to reserve the meeting space for the user for the first time period; and
initiate a meeting for the user at the meeting space for a duration of the first time period.

12. The communal meeting device of claim 11, further comprising:
one or more sensors and one or more inputs to detect the activity, wherein the activity includes one or more of a motion, a sound, a connection of a client device to the communal meeting device, and an initiation of an unscheduled meeting through the communal meeting device.

13. The communal meeting device of claim 11, wherein the first time period ends based on one of a default time period, pre-set time slots, and a start time of a next scheduled meeting within the meeting space.

14. The communal meeting device of claim 11, wherein the processors are further configured to monitor the activity of the user within the meeting space throughout the first time period.

15. The communal meeting device of claim 14, wherein the processors are further configured to one of:
delete the meeting for the user before or upon an expiration of the first time period in response to detecting a discontinuation of the activity within the meeting space; and
upon the expiration of the first time period, extend the meeting for the user at the meeting space for a duration of a second time period in response to detecting a continuation of the activity within the meeting space.

16. The communal meeting device of claim 15, wherein the second time period starts at the expiration of the first time period and ends based on one of a default time period, pre-set time slots, and a start time of a next scheduled meeting within the meeting space.

17. A system to reserve a meeting space through a communal meeting device located within the meeting space, the system comprising:
a server configured to execute a communication service; and
a communal meeting device comprising:
a communication interface configured to facilitate communication between the communication service and the communal meeting device;
a memory configured to store instructions; and
one or more processors coupled to the memory, wherein the one or more processors, in conjunction with the instructions stored in the memory, are configure(to:
detect an activity of a user within the meeting space;
determine whether the meeting space has a scheduled meeting that intersects with a first time period, wherein the first time period starts with the detection of the activity;
in response to a determination that the meeting space does not have a scheduled meeting that intersects with the first time period, transmit a request to a communication service to reserve the meeting space for the user for the first time period;
initiate a meeting for the user at the meeting space for a duration of the first time period; and
extend the meeting for the user at the meeting space for a duration of a second time period in response to detecting a continuation of the activity within the meeting space upon an expiration of the first time period.

18. The system of claim 17, wherein the one or more processors are further configured to:
determine an identity of the user within the meeting space through one or more sensors and one or more inputs of the communal meeting device.

19. The system of claim 18, wherein the one or more processors are further configured to:
provide the identity of the user to the communication service, wherein the communication service is configured to associate the identified user with the meeting space.

20. The system of claim 18, wherein the one or more processors are further configured to:
record the meeting space for a duration of the meeting through the one or more sensors and one or more inputs of the communal meeting device; and
send the recording to the identified user.
